(19) United States
(12) Patent Application Publication
(10) Pub. No.: US 2017/0148134 A1
(43) Pub. Date: May 25, 2017

(54) DRIVING CIRCUIT AND OPERATING METHOD THEREOF

(71) Applicant: Raydium Semiconductor Corporation, Hsinchu (TW)

(72) Inventor: Hung Li, Taipei City (TW)

(21) Appl. No.: 15/352,779

(22) Filed: Nov. 16, 2016

Related U.S. Application Data
(60) Provisional application No. 62/257,280, filed on Nov. 19, 2015.

(51) Int. Cl. G06T 1/60; G09G 5/393; G09G 3/36

(52) U.S. Cl. CPC G06T 1/60; G09G 3/3611; G09G 5/393; G09G 2360/18

(57) ABSTRACT

A driving circuit and an operating method thereof are disclosed. The driving circuit is disposed in a display apparatus and coupled to a display panel. The driving circuit includes a buffer module, a regenerating module, a data processing module and a driving module. The buffer module receives and temporarily stores a first image data. The regenerating module generates a second image data different from the first image data according to the first image data. The data processing module performs a data processing process on the second image data to generate an output image data. The driving module is coupled between the data processing module and the display panel and used to output the output image data to the display panel.

### BACKGROUND OF THE INVENTION

1. Field of the Invention

This invention relates to a display apparatus, especially to a driving circuit applied to a display apparatus and an operating method thereof.

2. Description of the Prior Art

In the conventional LCD apparatus, the driving IC receives the image data inputted from outside and the image data will be processed by the digital image processing circuit in the driving IC; then, the processed image data will be transmitted to the source driver to generate output voltage to the display panel.

In general, there will be the memory disposed in the driving IC to store the image data inputted from outside; for example, the driving circuit 1 of FIG. 1 includes a buffer module 13 which can be a frame buffer structure or a line buffer structure. Its main function is that when the inputting of data from outside is stopped, the image data stored in the buffer module 13 can be transmitted to the display panel PL to display, so that the frame display by the display panel PL will be not stopped because the inputting of data from outside is stopped.

Although the frame display by the display panel PL will be not stopped because the inputting of data from outside is stopped, the frame display by the display panel PL is only generated by directly static playing the image data stored in the memory without any variations. In addition, once the size of the image inputted from outside is far smaller than the size of the display frame, the driving circuit 1 will fail to process and the abnormal display phenomenon may be caused. These drawbacks in the above-mentioned prior arts should be overcome.

### SUMMARY OF THE INVENTION

Therefore, the invention provides a driving circuit applied to a display apparatus and an operating method thereof to solve the above-mentioned problems.

A preferred embodiment of the invention is a driving circuit. In this embodiment, the driving circuit is disposed in a display apparatus and coupled to a display panel. The driving circuit includes a buffer module, a regenerating module, a data processing module and a driving module. The buffer module receives and temporarily stores a first image data. The regenerating module generates a second image data different from the first image data according to the first image data. The data processing module performs a data processing process on the second image data to generate an output image data. The driving module is coupled between the data processing module and the display panel and used to output the output image data to the display panel.

In an embodiment, the driving circuit includes a transmission interface and another data processing module. The transmission interface is used for receiving an input image data from outside. The another data processing module is coupled between the transmission interface and the buffer module and used for performing the data processing process on the input image data to generate the first image data to the buffer module.

In an embodiment, the regenerating module includes a control unit and a regenerating unit. The control unit is used for generating a control signal according to an image position information of the first image data and a display position information of the display panel. The regenerating unit is coupled to the control unit and the data processing module and used for generating the second image data to the data processing module according to the control signal and the first image data.

In an embodiment, the regenerating unit further receives a background image data and generates the second image data to the data processing module according to the control signal, the first image data and the background image data.

In an embodiment, the image position information of the first image data comprises a current position information, a target position information and a boundary information of the first image data.

In an embodiment, the regenerating module further includes a position information processing unit coupled to the control unit and used for generating the image position information of the first image data to the control unit according to a size information and a start display position information of the first image data.

In an embodiment, the regenerating module performs an enlarging and filling process on the first image data according to the control signal to obtain the second image data.

In an embodiment, the enlarging and filling process is to enlarge the first image data according to a magnification parameter; if the enlarged first image data is larger than a display region of the display panel, the regenerating module neglects a part of the enlarged first image data out of the display region; if the enlarged first image data is smaller than the display region of the display panel, the regenerating module repeats a last point or line data of the enlarged first image data or fills the enlarged first image data with a predetermined color.

In an embodiment, the regenerating module performs a repeating and filling process on the first image data according to the control signal to obtain the second image data.

In an embodiment, the repeating and filling process is to repeatedly display the first image data to fill a display region of the display panel; if an entire size of the repeated first image data is larger than the display region of the display panel, the regenerating module neglects a part of the repeated first image data out of the display region; if the repeated first image data is smaller than the display region of the display panel, the regenerating module repeats a last point or line data of the repeated first image data or fills the repeated first image data with a predetermined color.

In an embodiment, the regenerating module performs a dynamic display process on the first image data according to the control signal to obtain the second image data.

In an embodiment, the dynamic display process is to display the first image data on a start position and then display the first image data on at least one trajectory coordinate in order or randomly after a period of time, the at least one trajectory coordinate is a default coordinate or a random coordinate.

In an embodiment, the first image data is only displayed on the start position and the at least one trajectory coordinate, or the first image data is displayed gradually several times between the start position and the at least one trajectory coordinate.

In an embodiment, if the buffer module temporarily stores a plurality of first image data, the regenerating module displays the plurality of first image data in order or randomly on the start position and the at least one trajectory coordinate.

Another preferred embodiment of the invention is a driving circuit operating method. In this embodiment, the driving circuit operating method is used for operating a driving circuit disposed in a display apparatus. The driving circuit is coupled to a display panel. The driving circuit includes a buffer module, a regenerating module, a data processing module and a driving module. The regenerating module is coupled between the buffer module and the data processing module. The driving module is coupled between the data processing module and the display panel. The driving circuit operating method includes steps of: the buffer module receiving and temporarily storing a first image data; the regenerating module generating a second image data different from the first image data according to the first image data; the data processing module performing a data processing process on the second image data to generate an output image data; and the driving module outputting the output image data to the display panel.

Compared to the prior art, the driving circuit and operating method thereof in the invention have the following advantages and effects:

(1) No matter the inputting of the image data from outside to the driving circuit is stopped or not, the memory in the driving circuit only needs to store the image far smaller than the display frame, and the image can be displayed in the display frame through different display modes (e.g., the enlarging and filling process, the repeating and filling process or the dynamic display process).

(2) Under the condition of reducing circuit area and power consumption, the memory used and the amount of image data transmission can be reduced and the frame displayed by the panel can have different changing effects.

The advantage and spirit of the invention may be understood by the following detailed descriptions together with the appended drawings.

### BRIEF DESCRIPTION OF THE APPENDED DRAWINGS

FIG. 1 illustrates a schematic diagram of the driving circuit in the prior art.

FIG. 2 illustrates a functional block diagram of the driving circuit in an embodiment of the invention.

FIG. 3 illustrates a detailed schematic diagram of the regenerating module of FIG. 2.

FIG. 4A and FIG. 4B illustrate schematic diagrams of the display panel and the first image data respectively.

FIG. 5 illustrates a schematic diagram of the second image data obtained after the first image data of FIG. 4B is processed by the enlarging and filling process.

FIG. 6 illustrates a schematic diagram of the second image data obtained after the first image data of FIG. 4B is processed by the repeating and filling process.

FIG. 7 illustrates a schematic diagram of the second image data obtained after the first image data of FIG. 4B is processed by the dynamic display process.

FIG. 8A˜FIG. 8D illustrate schematic diagrams of the second image data at the first time˜the fourth time respectively.

FIG. 9A˜FIG. 9B illustrate different embodiments of gradually displaying image data is several times respectively.

FIG. 10 illustrates the flowchart of the driving circuit operating method of another embodiment of the invention.

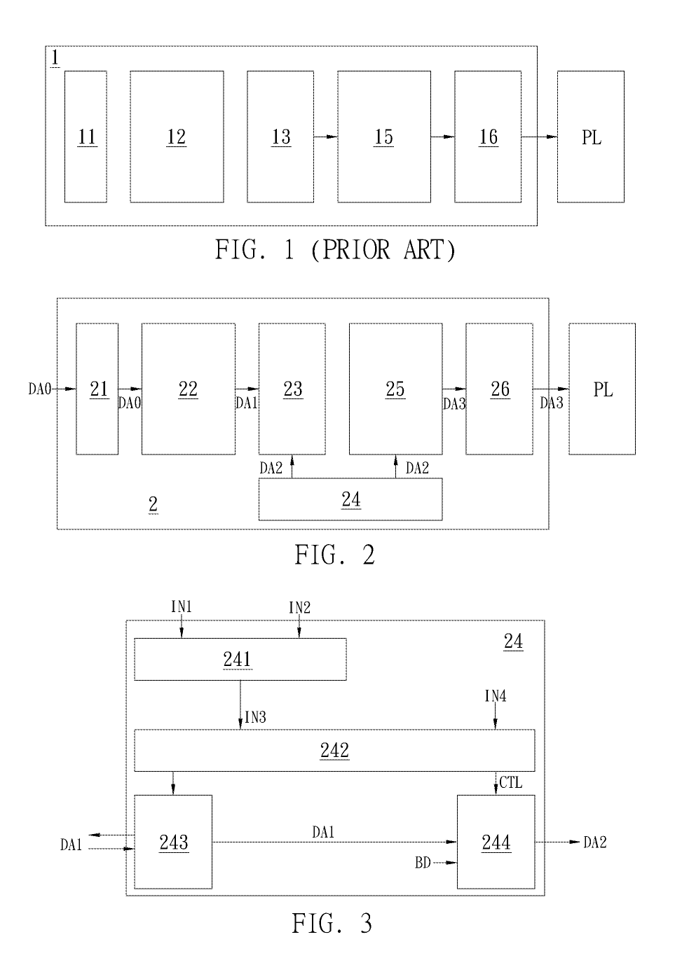

### DETAILED DESCRIPTION OF THE INVENTION

A preferred embodiment of the invention is a driving circuit. In this embodiment, the driving circuit is disposed in a LCD apparatus and coupled to a display panel, but not limited to this.

Please refer to FIG. 2. FIG. 2 illustrates a functional block diagram of the driving circuit in this embodiment. As shown in FIG. 2, the driving circuit 2 is coupled to the display panel PL. The driving circuit 2 includes a transmission interface 21, a first data processing module 22, a buffer module 23, a regenerating module 24, a second data processing module 25 and a driving module 26. Wherein, the first data processing module 22 is coupled between the transmission interface 21 and the buffer module 23; the regenerating module 24 is coupled between the buffer module 23 and the second data processing module 25; the driving module 26 is coupled between the second data processing module 25 and the display panel PL.

In this embodiment, the transmission interface 21 is used to receive an input image data DA0 from outside. The first data processing module 22 is used to perform a data processing process on the input image data DA0 to generate a first image data DA1 to the buffer module 23. The buffer module 23 is used to receive and temporarily store the first image data DA1. The regenerating module 24 is used to generate a second image data DA2 different from the first image data DA1 according to the first image data DA1. The second data processing module 25 is used to perform the data processing process on the second image data DA2 to generate an output image data DA3. The driving module 26 is used to output the output image data DA3 to the display panel PL.

Then, please refer to FIG. 3. FIG. 3 illustrates a detailed schematic diagram of the regenerating module 24 of FIG. 2. As shown in FIG. 3, the regenerating module 24 includes a position information processing unit 241, a control unit 242, a buffer control unit 243 and a regenerating unit 244. Wherein, the control unit 242 is coupled to the position information processing unit 241, the buffer control unit 243 and the regenerating unit 244 respectively; the buffer control unit 243 is coupled to the regenerating unit 244.

In this embodiment, the position information processing unit 241 is used to generate an image position information IN3 of the first image data DA1 to the control unit 242 according to a size information IN1 and a start display position information IN2 of the first image data DA1. In fact, the image position information IN3 can include a current position information, a target position information and a boundary information of the first image data DA1, but not limited to this.

The control unit 242 receives not only the image position information IN3 of the first image data DA1 transmitted by the position information processing unit 241, but also a display position information IN4 of the display panel; by doing so, the control unit 242 can generate a control signal CTL according to the image position information IN3 of the first image data DA1 and the display position information IN4 of the display panel.

The regenerating unit 244 receives not only the control signal CTL transmitted by the control unit 242, but also the first image data DA1 transmitted by the buffer control unit 243 and a background image data BD; by doing so, the regenerating unit 244 can generate the second image data DA2 to the second data processing module 25 according to the control signal CTL, the first image data DA1 and the background image data BD.

It should be noticed that, in practical applications, if there is no background image data BD, the regenerating unit 244 can also generate the second image data DA2 to the second data processing module 25 according to the control signal CTL and the first image data DA1 only, but not limited to this.

If there is no background image data BD, the regenerating unit 244 of the regenerating module 24 can perform different image processes on the first image data DA1 according to the control signal CTL to generate the second image data DA2. For example, the regenerating unit 244 can perform an enlarging and filling process, a repeating and filling process or a dynamic display process on the first image data DA1 to generate the second image data DA2, but not limited to this.

Next, different embodiments will be used to give detail as follows.

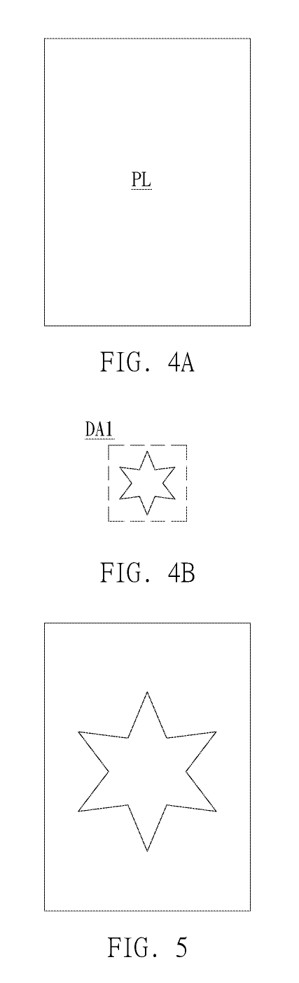

Please refer FIG. 5. FIG. 5 illustrates a schematic diagram of the second image data DA2 obtained after the first image data DA1 of FIG. 4B is processed by the enlarging and filling process. As shown in FIG. 5, the regenerating unit 244 performs the enlarging and filling process on the first image data DA1 according to the control signal CTL to generate the second image data DA2.

In detail, the enlarging and filling process performed by the regenerating unit 244 is to enlarge the first image data DA1 according to a magnification parameter (e.g., 40 times). If the enlarged first image data DA1 is larger than a display region of the display panel PL, the regenerating module 244 will neglect a part of the enlarged first image data DA1 out of the display region; if the enlarged first image data DA1 is smaller than the display region of the display panel PL, the regenerating module will repeat a last point or line data of the enlarged first image data DA1 or fills the enlarged first image data DA1 with a predetermined color.

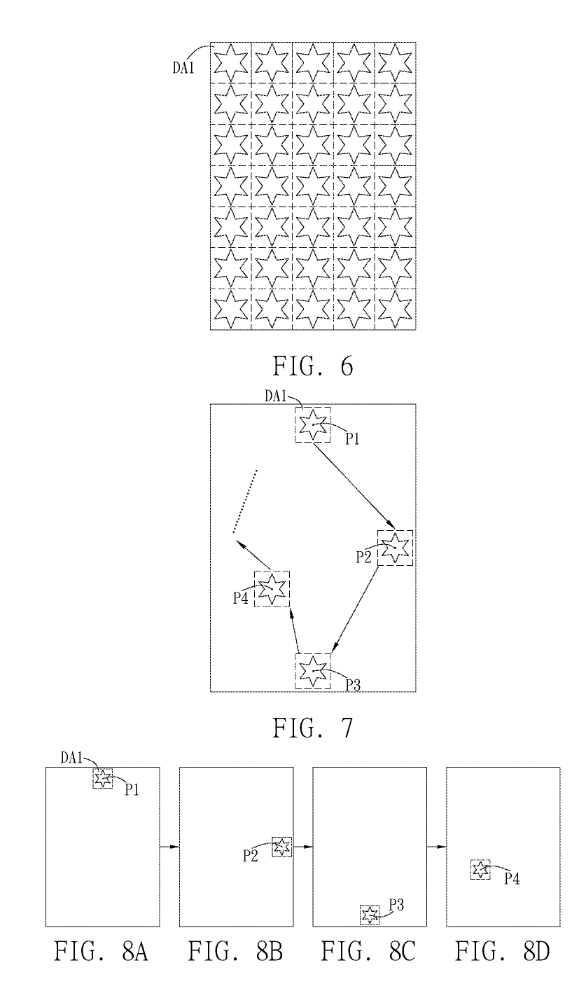

Please refer to FIG. 6. FIG. 6 illustrates a schematic diagram of the second image data DA2 obtained after the first image data DA1 of FIG. 4B is processed by the repeating and filling process. As shown in FIG. 6, the regenerating unit 244 performs the repeating and filling process on the first image data DA1 according to the control signal CTL to generate the second image data DA2.

In detail, the repeating and filling process performed by the regenerating unit 244 is to repeatedly display the first image data DA1 to fill the display region of the display panel PL. If an entire size of the repeated first image data DA1 is larger than the display region of the display panel PL, the regenerating module 244 will neglect a part of the repeated first image data DA1 out of the display region; if the repeated first image data DA1 is smaller than the display region of the display panel PL, the regenerating module 244 will repeat the last point or line data of the repeated first image data DA1 or fills the repeated first image data DA1 with a predetermined color.

Please refer to FIG. 7. FIG. 7 illustrates a schematic diagram of the second image data DA2 obtained after the first image data DA1 of FIG. 4B is processed by the dynamic display process. FIG. 8A˜FIG. 8D illustrate schematic diagrams of the second image data DA2 displayed on the first position P1˜the fourth position P4 at the first time˜the fourth time respectively.

As shown in FIG. 7, the regenerating unit 244 performs the dynamic display process on the first image data DA1 according to the control signal CTL to generate the second image data DA2.

In detail, the dynamic display process performed by the regenerating unit 244 is to display the first image data DA1 on a start position (e.g., the first position P1) and then display the first image data DA1 on at least one trajectory coordinate (e.g., the second position P2˜the fourth position P4) in order or randomly after a period of time. In fact, the at least one trajectory coordinate can be a default coordinate or a random coordinate without specific limitations.

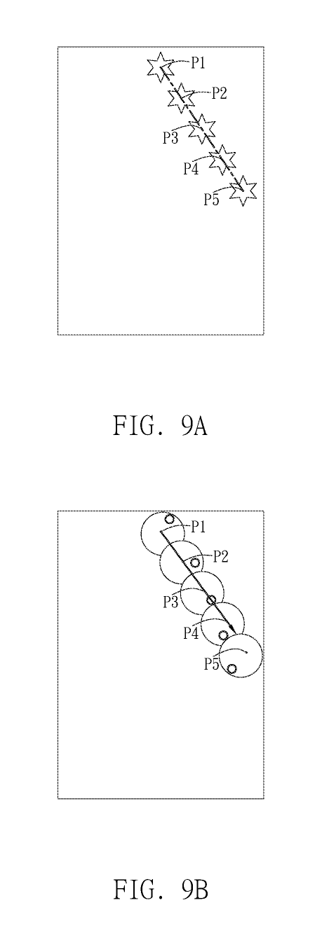

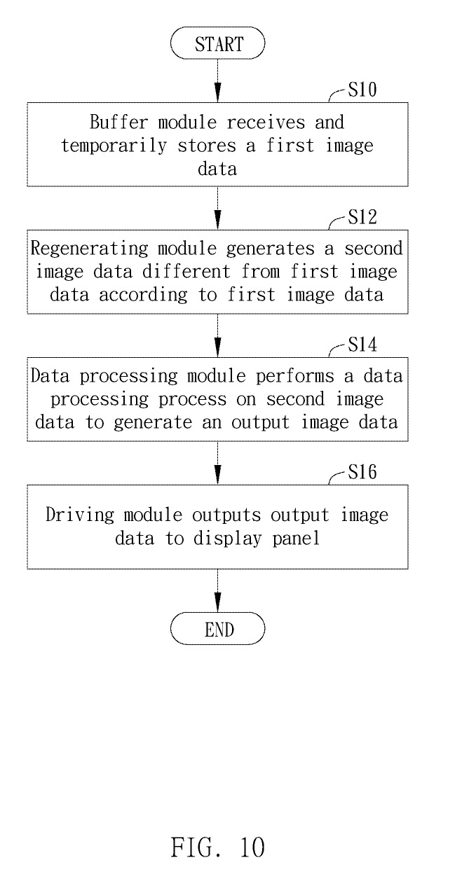

It should be noticed that, in the dynamic display process performed by the regenerating unit 244, the first image data DA1 can be only displayed on the start position (e.g., the first position P1) and the at least one trajectory coordinate (e.g., the second position P2˜the fourth position P4), or the first image data DA1 can be displayed gradually several times between the start position and the at least one trajectory coordinate, such as the different embodiments of gradually displaying image data several times respectively of FIG. 9A˜FIG. 9B. It should be noticed that as shown in FIG. 9B, when each time the first image data DA1 is gradually displayed, not only different display positions but also other changes (e.g., the rotation of an angle) to increase the variation of the display image.

In addition, if the buffer module 23 stores a plurality of first image data DA1 instead of one first image data DA1, then the regenerating module 24 can display the plurality of first image data DA1 on the start position and the at least one trajectory coordinate in order or randomly to increase the variation of the display image.

Above all, no matter the inputting of the image data DA0 from outside to the driving circuit 2 is stopped or not, the buffer module 23 in the driving circuit 2 only needs to store the first image DA1 far smaller than the display frame, and the first image DA1 can be processed by different ways (e.g., the enlarging and filling process, the repeating and filling process or the dynamic display process) and then displayed by the display panel. By doing so, the memory used and the amount of image data transmission can be reduced and the frame displayed by the panel can have different changing effects.

Another preferred embodiment of the invention is a driving circuit operating method. In this embodiment, the driving circuit operating method is used for operating a driving circuit disposed in a display apparatus. The driving circuit is coupled to a display panel. The driving circuit includes a buffer module, a regenerating module, a data processing module and a driving module. The regenerating module is coupled between the buffer module and the data processing module. The driving module is coupled between the data processing module and the display panel.

Please refer to FIG. 10. FIG. 10 illustrates the flowchart of the driving circuit operating method of this embodiment. As shown in FIG. 10, the driving circuit operating method includes following steps.

Step S10: the buffer module receives and temporarily stores a first image data;

Step S12: the regenerating module generates a second image data different from the first image data according to the first image data;

Step S14: the data processing module performs a data processing process on the second image data to generate an output image data; and

Step S16: the driving module outputs the output image data to the display panel.

Compared to the prior art, the driving circuit and operating method thereof in the invention have the following advantages and effects:

(1) No matter the inputting of the image data from outside to the driving circuit is stopped or not, the memory in the driving circuit only needs to store the image far smaller than the display frame, and the image can be displayed in the display frame through different display modes (e.g., the enlarging and filling process, the repeating and filling process or the dynamic display process).

(2) Under the condition of reducing circuit area and power consumption, the memory used and the amount of image data transmission can be reduced and the display frame can have different changing effects.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A driving circuit disposed in a display apparatus and coupled to a display panel, the driving circuit comprising:
a buffer module for receiving and temporarily storing a first image data; and
a regenerating module, coupled to the buffer module, for generating a second image data different from the first image data according to the first image data;
a data processing module, coupled to the regenerating module, for performing a data processing process on the second image data to generate an output image data; and
a driving module, coupled between the data processing module and the display panel, for outputting the output image data to the display panel.

2. The driving circuit of claim 1, further comprising:
a transmission interface for receiving an input image data from outside; and
another data processing module, coupled between the transmission interface and the buffer module, for performing the data processing process on the input image data to generate the first image data to the buffer module.

3. The driving circuit of claim 1, wherein the regenerating module comprises:
a control unit for generating a control signal according to an image position information of the first image data and a display position information of the display panel; and
a regenerating unit, coupled to the control unit and the data processing module, for generating the second image data to the data processing module according to the control signal and the first image data.

4. The driving circuit of claim 3, wherein the regenerating unit further receives a background image data and generates the second image data to the data processing module according to the control signal, the first image data and the background image data.

5. The driving circuit of claim 3, wherein the image position information of the first image data comprises a current position information, a target position information and a boundary information of the first image data.

6. The driving circuit of claim 3, wherein the regenerating module further comprises:
a position information processing unit, coupled to the control unit, for generating the image position information of the first image data to the control unit according to a size information and a start display position information of the first image data.

7. The driving circuit of claim 3, wherein the regenerating module performs an enlarging and filling process on the first image data according to the control signal to obtain the second image data.

8. The driving circuit of claim 7, wherein the enlarging and filling process is to enlarge the first image data according to a magnification parameter; if the enlarged first image data is larger than a display region of the display panel, the regenerating module neglects a part of the enlarged first image data out of the display region; if the enlarged first image data is smaller than the display region of the display panel, the regenerating module repeats a last point or line data of the enlarged first image data or fills the enlarged first image data with a predetermined color.

9. The driving circuit of claim 3, wherein the regenerating module performs a repeating and filling process on the first image data according to the control signal to obtain the second image data.

10. The driving circuit of claim 9, wherein the repeating and filling process is to repeatedly display the first image data to fill a display region of the display panel; if an entire size of the repeated first image data is larger than the display region of the display panel, the regenerating module neglects a part of the repeated first image data out of the display region; if the repeated first image data is smaller than the display region of the display panel, the regenerating module repeats a last point or line data of the repeated first image data or fills the repeated first image data with a predetermined color.

11. The driving circuit of claim 3, wherein the regenerating module performs a dynamic display process on the first image data according to the control signal to obtain the second image data.

12. The driving circuit of claim 11, wherein the dynamic display process is to display the first image data on a start position and then display the first image data on at least one trajectory coordinate in order or randomly after a period of time, the at least one trajectory coordinate is a default coordinate or a random coordinate.

13. The driving circuit of claim 11, wherein the first image data is only displayed on the start position and the at least one trajectory coordinate, or the first image data is displayed gradually several times between the start position and the at least one trajectory coordinate.

14. The driving circuit of claim 11, wherein if the buffer module temporarily stores a plurality of first image data, the regenerating module displays the plurality of first image data in order or randomly on the start position and the at least one trajectory coordinate.

15. A driving circuit operating method used for operating a driving circuit disposed in a display apparatus, the driving circuit being coupled to a display panel, the driving circuit comprising a buffer module, a regenerating module, a data processing module and a driving module, the regenerating module being coupled between the buffer module and the data processing module, the driving module being coupled between the data processing module and the display panel, the driving circuit operating method comprising steps of:
the buffer module receiving and temporarily storing a first image data;
the regenerating module generating a second image data different from the first image data according to the first image data;
the data processing module performing a data processing process on the second image data to generate an output image data; and
the driving module outputting the output image data to the display panel.

16. The driving circuit operating method of claim 15, wherein the driving circuit further comprises a transmission interface and another data processing module, the transmission interface receives an input image data from outside and the another data processing module performs the data processing process on the input image data to generate the first image data to the buffer module.

17. The driving circuit operating method of claim 15, wherein the regenerating module comprises a control unit and a regenerating unit, the control unit generates a control signal according to an image position information of the first image data and a display position information of the display panel and the regenerating unit generates the second image data to the data processing module according to the control signal and the first image data.

18. The driving circuit operating method of claim 17, wherein the regenerating unit further receives a background image data and generates the second image data to the data processing module according to the control signal, the first image data and the background image data.

19. The driving circuit operating method of claim 17, wherein the image position information of the first image data comprises a current position information, a target position information and a boundary information of the first image data.

20. The driving circuit operating method of claim 17, wherein the regenerating module further comprises a position information processing unit, and the position information processing unit generates the image position information of the first image data to the control unit according to a size information and a start display position information of the first image data.

21. The driving circuit operating method of claim 17, wherein the regenerating module performs an enlarging and filling process on the first image data according to the control signal to obtain the second image data.

22. The driving circuit operating method of claim 21, wherein the enlarging and filling process is to enlarge the first image data according to a magnification parameter; if the enlarged first image data is larger than a display region of the display panel, the regenerating module neglects a part of the enlarged first image data out of the display region; if the enlarged first image data is smaller than the display region of the display panel, the regenerating module repeats a last point or line data of the enlarged first image data or fills the enlarged first image data with a predetermined color.

23. The driving circuit operating method of claim 17, wherein the regenerating module performs a repeating and filling process on the first image data according to the control signal to obtain the second image data.

24. The driving circuit operating method of claim 23, wherein the repeating and filling process is to repeatedly display the first image data to fill a display region of the display panel; if an entire size of the repeated first image data is larger than the display region of the display panel, the regenerating module neglects a part of the repeated first image data out of the display region; if the repeated first image data is smaller than the display region of the display panel, the regenerating module repeats a last point or line data of the repeated first image data or fills the repeated first image data with a predetermined color.

25. The driving circuit operating method of claim 17, wherein the regenerating module performs a dynamic display process on the first image data according to the control signal to obtain the second image data.

26. The driving circuit operating method of claim 25, wherein the dynamic display process is to display the first image data on a start position and then display the first image data on at least one trajectory coordinate in order or randomly after a period of time, the at least one trajectory coordinate is a default coordinate or a random coordinate.

27. The driving circuit operating method of claim 25, wherein the first image data is only displayed on the start position and the at least one trajectory coordinate, or the first image data is displayed gradually several times between the start position and the at least one trajectory coordinate.

28. The driving circuit operating method of claim 25, wherein if the buffer module temporarily stores a plurality of first image data, the regenerating module displays the plurality of first image data in order or randomly on the start position and the at least one trajectory coordinate.
